(19) United States
(12) Patent Application Publication
(10) Pub. No.: US 2026/0150789 A1
(43) Pub. Date: Jun. 4, 2026

(54) METHOD OF REVEGETATING A NATIVE PLANT COMMUNITY

(71) Applicant: Dean MacKenzie, Sherwood Park (CA)

(72) Inventor: Dean MacKenzie, Sherwood Park (CA)

(21) Appl. No.: 18/964,967

(22) Filed: Dec. 2, 2024

(51) Int. Cl. A01G 2/00; A01G 9/029; A01G 22/00

(52) U.S. Cl. CPC A01G 2/00; A01G 9/0291; A01G 9/0299; A01G 22/00

(57) ABSTRACT

A method of revegetating a native plant community such as a forest includes the steps of mechanically collecting forest floor material, specifically targeting native plant seeds, spores, and acrotelm layers, to restore native forest species. The collected material is formed into small pieces, such as pucks, for distribution on the target land. The pieces are formed by wetting the material with water and a binder as a wetting agent, mechanically compressed and dried to a moisture content less than 15% by volume. Each piece has a surface area of less than 25 sq cms and a thickness of less than 1.5 cms so that the pieces are smaller than the smallest length required for a root to emerge into a new plant. The process ensures that the material cannot dry out as the vegetative propagules die if it does. The material is formed into the pieces without being stockpiled or previously stored and without freezing.

This invention relates to a method of revegetating a native plant community that has native seeds and mosses such as forest but also including mineral wetlands and grasslands includes the steps of mechanically collecting floor material comprising seeds, spores and non vascular clonal structures of plant life, forming the material into pieces such as pucks containing the material for revegetation and transporting and distributing the pieces on land to be revegetated.

The following discusses primarily the use of this method in revegetation of forests but the same method steps can be applied to any native plant community that has native seeds and mosses such as forest but also including mineral wetlands and grasslands.

Establishing native forest vegetation after a disturbance (e.g. a wellsite or mine) or in areas where forest vegetation did not previously exist can be costly and time-consuming. Seeds or propagules from native forest vegetation may not be obtainable from traditional sources such as greenhouses, nurseries or seed cooperatives. As an increasing amount of forests are being disturbed there has been a corresponding increasing societal and regulatory demand for re-establishment of native forest vegetation.

Collection and planting of soil plugs can establish native boreal plants; however, this method is very labor intensive and costly. An additional cost associated with planting soil plugs is the additional time required to hand dig holes for planting the plugs on the land where native forest vegetation is desired. Soil plugs are not compressed and transporting plugs without causing damage to the integrity of the plug is difficult.

The use of forest floor material, such as the organic matter horizon that accumulates on the mineral soil surface under forest vegetation (referred to as LFH), which can contain thousands of seeds and vegetative propagules from many different native forest species, has been shown to be an effective way of establishing native forest vegetation. Forest floor material also contains nutrients, micro-organisms and soil fauna and provides water holding capacity which improves the growth of forest species.

Currently, forest floor material may be salvaged prior to the initiation of anthropogenic disturbances. The bulked material is then transported to land where native forest vegetation is desired and a continual layer of the forest floor material is spread on the surface of the land. However, the forest floor material is usually stockpiled and stockpiling reduces the viability of the seeds and vegetative propagules. Additionally, there may not always be stockpiled material at the time it is needed for reclamation.

Salvaging forest floor material from other locations and transporting to the land where native forest vegetation is to be established could overcome the above limitations; however, transporting the required quantity of material is often not economically feasible and the material may still have to be stored, reducing the viability of seeds and vegetative propagules.

Compacting or compressing the forest floor material reduces transportation costs. In its bulked form, forest floor material has a lower density and vehicles used for transportation can be loaded to their maximum volume (but not to their maximum weight). If the material is compressed, then the vehicles may be loaded to both their maximum volume and weight. Compressed forest floor material creates additional benefits for plant establishment, such as improved moisture retention, nutrient concentration and soil to propagule contact.

A continual layer of compressed forest floor material may not need to be applied to land where the native forest vegetation is desired, as there is a higher concentration by volume of seeds and vegetative propagules contained in the compressed material (and in the bricks, slabs, wafers, pellets or any other shape of the compressed material, referred to herein as “Products”) allowing the material to be evenly distributed with spaces between each Product. Vegetation established from the Products could fill in the spaces between the Products

Direct placement of forest floor material at shallow depths does not provide good seed/vegetative propagule to soil contact; therefore, many seeds/vegetative propagules dry out and die. Large equipment cannot move through existing reclaimed forested areas without disturbing the trees and other plants.

Attempts have been made to mix the forest floor materials with a mulch or hydro mulch, which does not preserve all seeds and vegetative propagules in the material. Processing forest floor materials results in the destruction of vegetative propagules. These methods require specialized amendments and equipment for processing and application and the specialized equipment likely cannot move through existing reclaimed forested areas. The pucks herein will also eliminate vegetative propagules while leaving behind organic matter, nutrients, and seeds.

The forest floor material may be collected when plant life in the forest is dormant. The forest floor material may be wetted to the point of saturation. The wetting agent may be water, or an emulsifier. The forest floor material may be frozen using atmospheric conditions or refrigeration. The material may be frozen within 90 days of collection, and the smaller shapes may each have a volume of less than 1 m 3 .

One previous proposal for this method is set out in a patent for the Restart technology described in U.S. Pat. No. 10,143,143 B2 published Dec. 4, 2018.

The above patent sets out a method of re-establishing native forest vegetation is provided, including the steps of: collecting a volume of forest floor material; wetting the volume of material with a wetting agent or another fluid with or without amendments/augmentation; compressing the wetted forest floor material; freezing the compressed forest floor material; separating the frozen forest floor material into a plurality of smaller pieces; storing the frozen pieces in a frozen environment; and distributing at least a portion of the pieces on land to be revegetated.

In the above process, freezing of the pieces of pucks is essential. This patent states that freezing provides the following essential effects:

It acts to maintain seed and vegetative propagule viability and germination/emergence.

Freezing the forest floor material allows for efficient handling and transport of the material without causing damage to the propagules within. Forming various sized shapes, such as bricks, slabs, wafers, pellets or other shapes of the forest floor material when it is frozen helps maintain the increased density of the material after compression has occurred.

Additionally, freezing the forest floor material helps maintain the viability of the propagules within. Wetted or saturated forest floor material should be frozen within a short time frame of salvaging, such as less than 90 days, to preserve seed and vegetative propagule viability. Freezing the forest floor material prevents the material from drying out, slows respiration of tissue and preserves carbohydrate reserves of vegetative propagules and prevents germination of seeds.

The previous process was developed to keep seeds and vegetative propagules (Roots) alive to regrow. It was established and set out in the patent at that time that the smallest dimensions allowed in the pucks 5 cm×5 cm×5 cm (0.05 meters) were based on the smallest length required for a root to emerge into a new plant. Any such roots having a length less than 5 cm are not expected to regenerate as required.

### SUMMARY OF THE INVENTION

According to the invention there is provided a method of revegetating a native plant community, comprising the steps of:
mechanically collecting floor material comprising of seeds, spores and non vascular clonal structures of plant life;
wetting the forest floor material with a wetting agent and binder;
mechanically compressing the floor material;
drying the wetted and compressed floor material between to a moisture content less than 15% by volume;
forming the floor material into a plurality of separate compressed and dried pieces;

where each piece has a surface area of less than 25 sq cms and a thickness of less than 1.5 cms;
storing the compressed and dried pieces in without freezing; and
transporting and distributing the pieces on land to be revegetated.

In the present application, for upland forests the method acts only to preserve the seed and this differs from the above prior patent as that method focuses on vegetative propagules. For peat the acrotelm layer is vegetative, just not woody plant.

For this application, vegetative propagules is only referring to non-vascular clonal structures such as gametophytes and protonemata. The non-vascular clonal structures are contained in the acrotelm layer of peat. Seeds and spores referring to all forest types and non-vascular clonal structures is lowland forest or peatland.

The wetting step also includes addition of a binder. A binder is a substance that enhances cohesion. Examples of binders that could be used in this process include:

Starch-based Binders: Cornstarch, potato starch, or rice starch can act as natural adhesives, helping hold the organic material together in compressed pucks or pellets.

Cellulose or Hemicellulose Derivatives: Derived from plant fibers, these can improve structural integrity. Examples include carboxymethyl cellulose and microcrystalline cellulose.

Natural Gums: Gums like guar gum or xanthan gum, derived from plants, are effective binders that also add some water retention capacity.

Flour or Grain-Based Binders: Simple flours, such as wheat or oat flour, work well for cohesion and are biodegradable.

Lignosulfonates: By-products from the paper industry, these lignin-based binders are natural adhesives and can enhance moisture retention.

Biochar: While typically used as a soil amendment, biochar can be finely ground and mixed to act as a mild binding agent, adding structural stability and nutrient retention.

Molasses or Sugar Syrup: Molasses is sticky, biodegradable, and can provide slight nutrients for the plants while enhancing puck integrity.

Tackifiers: Tackifiers from natural sources, like cereal or hemp straw, create a lightweight binding effect ideal for holding lightweight materials together.

The process of the above prior patent was originally developed to keep seeds and vegetative propagules (Root) alive. The smallest dimensions (5 cm×5 cm×5 cm) were based on the smallest length required for a root to emerge into a new plant. The present process ensures that the material cannot dry out as the vegetative propagules die if it does.

With regard to dimensions, preferably the pieces or pucks have a surface area of less than 7.07 sq cm. Deployment for larger sizes is uncertain. Preferably the pucks have a thickness between 1 cm and 1.5 cm.

The puck could be thicker, up to 3 cm, but it is ideal between 1 and 1.5 cm.

Preferably the method includes drying to a moisture content between to 5% and 15% ideally 10% to 15%,

In some embodiments, the pieces can be preloaded with seeds from targeted tree and/or shrub species.

In some embodiments, the pieces can be arranged and packaged in a manner that can allow the pieces to be dropped from a drone.

In some embodiments, the pieces can be deployed with pre-germinated plants.

In some embodiments, the pieces can be formed from live material by wetting and adding a binder and for long-term storage and hardened into each piece which forms a pellet.

Preferably seed-to-soil contact is ensured by the level of compression selected.

Preferably forest floor material is dried at 30 to 40 degrees Celsius for more than 12. This can be up to 24 hours or longer times such as up to 72 hours may be needed for cooler temperatures. Drying over a shorter period of time prevents seeds from germinating within the puck.

Preferably the drying to the moisture content defined above in the manner defined above prevents the seeds from germinating or rotting.

Preferably the collected material comprises live forest floor, specifically the LFH (Litter, Fermentation, and Humus) horizons.

Preferably the forest floor material is wetted, compressed and dried without being stockpiled or previously stored.

Preferably the forest floor material contains seeds from all species within the forest.

Preferably the forest floor material is collected from the upper 10 to 30 cm, the acrotelm layer, which contains viable moss fragments and spores that can be reproduced.

Preferably the forest floor material when compressed and dried contains native plant species that establish from the seeds not from roots.

In some embodiments, the pieces can have a density after compression between 0.3 g/cm³ and 0.8 g/cm³.

Preferably the wetting agent comprises water, water and fertilizer and may include an emulsifier.

### BRIEF DESCRIPTION OF THE DRAWINGS

FIG. 1 is a flow chart showing the method according to the invention.

### DETAILED DESCRIPTION

For the purpose of this document “forest floor material” refers to the organic material (partial or entire layers/horizons) or a mix of the organic material with the upper portion (e.g. upper 30 cm) of mineral soil from upland, lowland or transitional land. Upland refers to land that is dry long enough to promote upland forest processes, indicated by imperfect to rapidly drained soil and non-hydrophilic vegetation. Lowland refers to land that is saturated with water long enough to promote wetland or aquatic processes, indicated by poorly drained soil and hydrophilic vegetation. Transitional refers to land with soils that are developed on mineral material under forest in locations with imperfect drainage or wetter, typically including an organic horizon over a mineral horizon. An actual forest may or may not be present and forest floor material may be developed on natural undisturbed lands, disturbed lands, restored or reclaimed lands or revegetated stockpiles.

For the purpose of this document “organic material” refers to LFH, peat, organic soil and muskeg. As mentioned above, LFH refers to the forest floor material that accumulates on the mineral soil surface under forest vegetation, which includes litter and unincorporated humus. The term LFH or LFH-mineral mix is a common term used to describe the forest floor material from an upland forest; other terms that have been used include forest floor-mineral mix, forest litter, litter, upland surface soil or the duff layer. Peat is organic material constituting peat lands comprised largely of organic residues accumulated as a result of incomplete decomposition of dead plant constituents under conditions of excessive moisture (submergence in water and/or waterlogging). Organic soil refers to an order of soils that have developed dominantly from organic deposits. The majority of organic soils are saturated for most of the year, unless artificially drained, but some of them are not usually saturated for more than a few days. Organic soils contain more than 17% organic carbon by weight. Muskeg is a layman's term used to describe peat and organic soils.

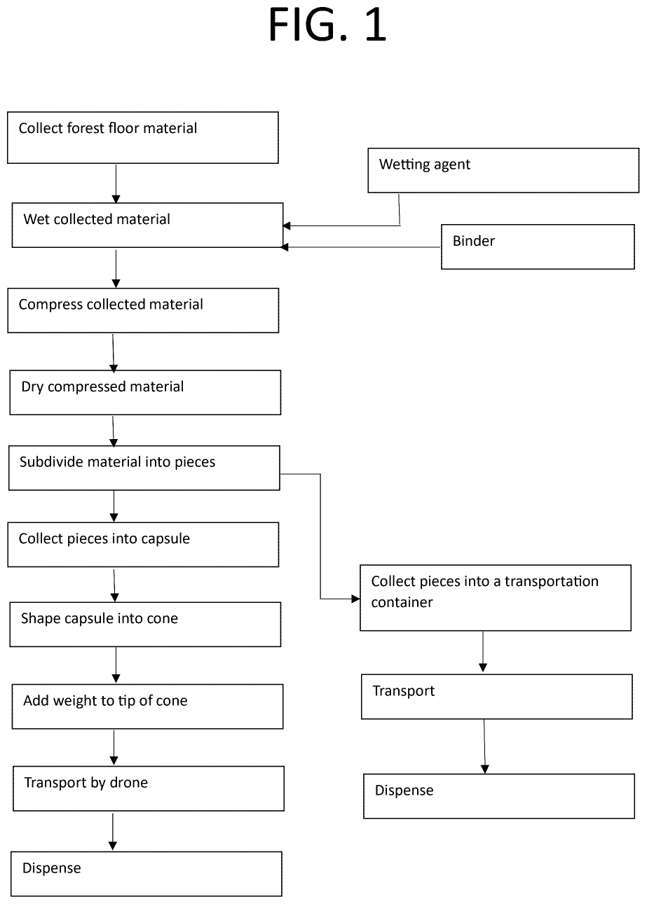

Referring to FIG. 1, the process begins with the collection of forest floor material. Although collection can occur at any time of year because root preservation is not required, the period immediately following seed dispersal of targeted species is preferred to maximize seed content. Collection during dormancy (fall, winter, or early spring) is often advantageous, as it helps preserve the viability of seeds. The forest floor material is typically collected using a bobcat, bulldozer or any other efficient piece of machinery (excavator, scraper, etc.). The forest floor material with the greatest amount of viable seeds should be selected. The forest floor material should contain less than 50% mineral soil by volume to prevent the seeds from being diluted with non-propagating material. To further concentrate propagules within the forest floor material, rocks, large stumps and woody material can be screened out of the forest floor material.

A wetting agent is then added to the collected forest floor material to a point where the material becomes moist, wet or saturated. The wetting agent may be water, a mixture of water and fertilizer, smoke water, non-ionic surfactant, emulsifier, polymers, or mixtures thereof, or any amendment that promotes germination and enhances water retention. The wetness of the forest floor material may depend on the type of forest floor material being used. Alternatively, as described later, the wetting can take place after compression.

The wetted or saturated forest floor material is then compressed. Wet or saturated forest floor material can be compressed using a device that can press the forest floor material into the desired molds. The compression can be done at the location where forest floor material is salvaged and collected or at a different location. The forest floor material should be compressed to various degrees, but should be compressed to a density between 0.3 g/cm³ and 0.8 g/cm³.

Compression of the forest floor material helps concentrate propagules and provides a dense medium that allows for excellent seed/propagule to soil and/or organic material contact. The forest floor material can be compressed into various sizes and shapes as desired for ease of storage, transport and later distribution. Bricks, slabs, wafers, pellets or other shapes may be used. If the forest floor material has not yet been wetted, or alternatively, is to be wetted again, then the material should be wetted, The wetness of the forest floor material will depend on the type of forest floor material being used.

The collected material consists of live forest floor, specifically the LFH (Litter, Fermentation, and Humus) horizons of upland, transitional and lowland forests in Canada. This material is not stockpiled or previously stored, which is critical and markedly different from how typical horticultural peat is managed. The natural material contains seeds from all species within the forest, and for many of these species, this method is the only way to harvest their seeds at scale. In peatlands, we collect from the upper 10 to 30 centimeters, the acrotelm layer, which contains viable moss fragments and spores that can be reproduced.

Prior to compression, the material is screened to remove larger fragments of wood and roots. It is then wetted to saturation, with moisture content varying depending on the type of material. An organic binder—such as starch, flour, or a tackifier made from cereals or hemp straw—may be added to strengthen the puck after compression.

After compression, the pucks are dried at 30 to 40 degrees Celsius for 12 to 24 hours, depending on the original moisture content of the material. The moisture content should be reduced to between 5% and 15%, ideally 10% to 15%, to prevent mold growth and to avoid desiccating the seeds.

The density of pucks made from upland forest floor ranges between 0.3 g/cm³ and 0.8 g/cm³. This density depends on factors such as the addition of a binder, the type of material used, and how finely roots and larger organic chunks are screened out.

The pucks vary in size from 1 cm² to 7.07 cm². Larger sizes up to 25 cm² are possible, but their deployment feasibility is uncertain. The pucks have a thickness between 1 cm and 1.5 cm.

The material is collected live and is not stored in piles with a moisture content exceeding 10% to 15% for any extended period (less than 30 days). Our focus is on native plant species that establish from the seeds, spores and/or non-vascular clonal structures we are preserving, not from roots. This application is beneficial for enhancing native plant diversity on disturbed lands (natural and man made). For live peat material, we are preserving moss fragments (non-vascular clonal structures) and spores. I also tested the germination of conifer seeds added to these pucks, and it's excellent, so there is an option to preload these with targeted tree and shrub species.

The pucks can be deployed using various methods that broadcast them onto the surface, such as drones, utility terrain vehicles (UTVs), standard vehicles, or tractors.

The method herein also uses a deployment capsule that can be dropped from a drone, allowing the plants established from these small pucks to penetrate soft ground. These pucks can also be deployed with pre-germinated plants. The capsules are made entirely from organic materials, some of which are derived from agricultural waste and mycelium.

The method also incorporates the use of deployment capsules, which are designed to enhance the placement and establishment of revegetation pucks. The capsules are made of biodegradable materials, including mycelium composites from agricultural or wood fibers, or pulp-based media such as recycled paper, mixed pulp and peat, or wood. The selection of capsule material depends on the specific deployment requirements, particularly the longevity and resistance to moisture exposure.

The capsules are conically shaped, with a narrow point designed to penetrate into the ground effectively and a wider base that provides stability for the puck during both transport and deployment. This conical design ensures that the puck remains secure within the capsule, minimizing movement and potential damage during aerial drops. The capsules can be dropped from drones, allowing for precise placement, especially in challenging terrains such as soft ground or areas with dense vegetation.

Capsules made from pulp-based fibers are intended for short-term use, designed to biodegrade rapidly upon exposure to moisture. These capsules are ideal for situations where quick decomposition is beneficial, such as when pucks without pre-emerged plants are used or when pre-emerged plants are inserted just before deployment. To enhance the durability or resistance of pulp-based capsules, a thin layer of beeswax can be sprayed inside the capsule. The wax layer is less than 0.5 mm thick, ensuring that upon entry into the soil, the capsule still allows water to reach the puck effectively. This ensures the capsule does not degrade prematurely, maintaining structural integrity until after deployment.

For more durable applications, capsules composed of mycelium composites or wood are used. These materials are more resistant to deformation and are suitable for scenarios where pre-germinated plants need to grow within the capsules before deployment. The durability of these capsules ensures that they can sustain moisture exposure during early plant development while still being biodegradable over time.

To improve deployment accuracy, the tips of capsules made from pulp fibers or mycelium composites can be weighted by mixing the base material with a denser natural substance, such as sand. The added weight helps ensure straighter drops during windy conditions and aids in the penetration through shrub canopies and compacted organic layers. This added weight is particularly useful when deploying capsules in areas where dense vegetation or previously compacted organic matter could obstruct proper placement.

All capsules may be coated externally with a thin layer of a friction-reducing biodegradable coating, such as beeswax, to help minimize resistance during penetration into the ground. Additionally, capsules made from mycelium composites or wood are designed with slots or holes to allow for water and air exchange, which is crucial for root development. These openings also facilitate root growth beyond the capsule, promoting successful establishment of the plants in the surrounding soil.

The capsule can be used as one way for deployment and that would only be for dropping onto wetland soil, organic soil or peatland forests.

Additional deployment methods these pucks can be deployed is with the puck having plants that have already emerged, kind of like a treed seedling except we are just applying these to the surface and the native plants are much smaller so significantly less time needed to grow in greenhouse. However, the most likely scenario is they are deployed via broadcast using typical drone, hand, or hopper-style broadcast methods.

In the present method, the method does not freeze the material for storage but instead dries it for long term storage. The new drying process is inconsistent with the previous process. That is the drying is consistent with storing the seeds but not with storing the roots which will die. The pucks used are smaller than can be accepted for the old process and too small to accommodate the roots.

The new process only focuses on seeds, and the units are smaller than 5 cm×5 cm. This makes it easier to store them in bags and handle them with regular broadcasting equipment, either mechanical, hand, or drone. Similar to the original process, only living forest floor material or litter from native plant communities is used. The live material is compressed by wetting and adding a binder, which is then dried and harden into a pellet for long-term storage. Compressing it ensures seed-to-soil contact, and drying prevents the seeds from rotting.

What makes the pellets unique is that we collect seeds of native plant species that are not available commercially since they are too challenging to collect. However, we can collect these species by gathering the forest floor or litter and concentrating the topsoil, which concentrates the seed itself.

1. A method of revegetating a native plant community, comprising the steps of:
mechanically collecting floor material comprising of seeds, spores and non vascular clonal structures of plant life;
wetting the forest floor material with a wetting agent and binder;
mechanically compressing the floor material;
drying the wetted and compressed floor material between to a moisture content less than 15% by volume;
forming the floor material into a plurality of separate compressed and dried pieces;
where each piece has a surface area of less than 25 sq cms and a thickness of less than 1.5 cms;
storing the compressed and dried pieces in without freezing; and
transporting and distributing the pieces on land to be revegetated.

2. The method according to claim 1 wherein the pieces have a surface area of less than 7.07 sq cm.

3. The method according to claim 1 wherein the pieces have a thickness between 1 cm and 1.5 cm.
The method according to claim 1 wherein the method includes drying to a moisture content between to 5% and 15% ideally 10% to 15%,

5. The method according to claim 1 wherein the pieces are preloaded with seeds from targeted plant species.

6. The method according to claim 1 wherein the pieces are arranged and packaged in a manner that can allow the pieces to be dropped from a drone.

7. The method according to claim 6 wherein a plurality of pieces are packaged into a deployment capsule to be dropped from the drone where the capsule is conically shaped, with a narrow point designed to penetrate into the ground effectively and a wider base that provides stability for the pieces during both transport and deployment wherein the conical shape ensures that the pieces remain secure within the capsule, minimizing movement and potential damage during aerial drops.

8. The method according to claim 7 wherein a tip of the capsule is weighted by mixing the base material with a denser natural substance where the added weight helps ensure straighter drops during windy conditions and aids in the penetration through shrub canopies and compacted organic layers.

9. The method according to claim 1 wherein the pieces include pre-germinated plants.

10. The method according to claim 1 wherein the drying is arranged to prevent the seeds from rotting.

11. The method according to claim 1 wherein the collected material comprises live floor, specifically the LFH (Litter, Fermentation, and Humus) horizons.

12. The method according to claim 1 wherein the floor material is wetted, compressed and dried without being stockpiled or previously stored.

13. The method according to claim 1 wherein the floor material contains seeds from all species.

14. The method according to claim 1 wherein the floor material is collected from the upper 10 to 30 centimeters, the acrotelm layer, which contains viable moss fragments and spores that can be reproduced.

15. The method according to claim 1 wherein the floor material when compressed and dried contains native plant species that establish from the seeds not from roots.

16. The method according to claim 1 wherein are dried at 20 to 40 degrees Celsius for at least 12 hours.

17. The method according to claim 1 wherein a density of the pieces is between 0.3 g/cm³ and 0.8 g/cm³.

18. The method according to claim 1 wherein the wetting agent comprises water.

19. The method according to claim 1 wherein the wetting agent comprises water and fertilizer.

20. The method according to claim 1 wherein the wetting agent comprises an emulsifier.
